(19) United States
(12) Patent Application Publication
(10) Pub. No.: US 2008/0046386 A1
(43) Pub. Date: Feb. 21, 2008

(54) Method for making optimal decisions in automated customer care

(76) Inventors: Roberto Pieraccinii, Peekskill, NY (US); Zor Gorelov, North Caldwell, NJ (US)

Correspondence Address: FROMMER LAWRENCE & HAUG, 745 FIFTH AVENUE- 10TH FL., NEW YORK, NY, 10151, US

(21) Appl. No.: 11/824,657

(22) Filed: Jul. 2, 2007

Related U.S. Application Data
(60) Provisional application No. 60/806,483, filed on Jul. 3, 2006.

(51) Int. Cl. G06F 17/00; G07B 17/02

(52) U.S. Cl. 705/402

(57) ABSTRACT

This invention relates to a method for optimizing the cost of interaction with a caller utilizing an automated interactive voice response system. A plurality of interactions between a caller and an automated interactive voice response system are analyzed. Discrete attributes of the interactions between the callers and the automated interactive voice response system are analyzed, and a set of logical statements relative to the discrete attributes is formulated. The set of logical statements is applied to the interaction with the caller, from which an action is determined.

### CROSS REFERENCES TO RELATED APPLICATIONS

The present invention claims priority to U.S. Provisional Application 60/806,483, filed Jul. 3, 2006, the entire contents of which being incorporated herein by reference.

### BACKGROUND OF THE INVENTION

Companies that provide services and products to consumers face the problem of the increasing costs of customer care. In most situations the cost of a customer care telephone call is evaluated in terms of its duration, both for human agents as well as for the time spent in automated Interactive Voice Response (IVR) systems, which could be thought of as instances of automated agents. In fact in case of human (or live) agents, the cost of a call is proportional to the per-minute cost attributed to highly trained representatives plus telecommunications costs calculated on a per minute basis. In the case of automated agents, the cost of a call is proportional to the capital and operational costs attributed to providing the automated agents including hardware, software and ongoing maintenance, and also to telecommunications costs calculated on a per minute basis. Therefore, the reasonable assumption can be made that the per-minute cost of a human agent is higher than the corresponding cost of an automated agent. At the same time in a competitive market environment, the quality of customer care as experienced by the customer needs to be maintained at the highest possible level. In other words, any reduction in the cost per call must be obtained without sacrificing the quality of the customer experience.

The minimization of the cost per call and the optimization of the customer experience are often conflicting criteria, and the optimal point is often found by using heuristic considerations. Most often in a human agent situation the decision on how to handle a caller is left to the judgment of the individual agent. Similarly, with automated IVR interactions the decisions on how to handle a caller is specified in the design of the IVR strategy (call-flow), and thus is left to the experience of the designers and their knowledge of the domain. Thus in both cases, with human agents and automated agents, the decisions taken at each point of the interaction are based on the experience of an individual (the human agent or the designer), rather than on a mathematical optimization of a well defined cost function. The problem is exactly the same if, instead of costs, possible gains or rewards are considered. The expression “costs” is used in the remaining description without any loss of generality.

As a concrete and simplified example of an automated speech recognition IVR system, consider an automated system for providing technical support for a product that, at any point in time during the interaction can decide to take one of the following actions:
Action 1: Continue with the process, as designed
Action 2: Escalate to the first available human agent.

The decision on whether to continue with the automated IVR process or escalate the call needs to take into account possible resulting outcomes, which are:

Continuation of the IVR interaction leads to the resolution of the caller's issue. This will result in a cost saving, since a human agent is definitely more expensive than an automated one. If this call had been escalated, the benefits of the cost reduction would have been lost.

Continuation of the IVR interaction does not lead to the resolution of the caller's issue, and then at the end, the call must be transferred to a human agent, or alternatively the caller hangs up because of frustration. If the call is transferred to a human agent after a long call, then the call will be more expensive because the cost of the IVR interaction needs to be added to the cost of the human agent's call. If the caller hangs up in the IVR out of frustration after a long and inconclusive call, the call delivers no benefit and has a negative effect on costs, i.e. there is no resolution of the customer problem. In that case, most likely, the caller will call again and get to a human agent. It would have been much better to escalate this call as early as possible.

The function to optimize, in this particular example, is the overall cost of customer care, i.e. human and automated agent costs plus telecommunications costs, per number of resolved calls (those calls that were completed successfully). Therefore, there is an optimal point during the call when the IVR automated agent needs to transfer the caller to a human agent in order to optimize the above conditions. That point is reached when there is enough evidence that the IVR agent cannot solve the problem. By transferring the call to a human agent too early, however one may miss the opportunity for the automated agent to successfully complete the call and benefit from the lower cost per minute. By transferring the call too late, one misses the opportunity to reduce the cost of the IVR by having a shorter call in the IVR and also one runs the risk of reduced customer satisfaction from a longer, unsuccessful IVR call.

The foregoing is a simplified example where the number of actions is restricted to two, i.e. transfer to a human agent or continue the call with an automated agent. However, the simple example does not imply any loss of generality of the problem. The problem can be extended to any arbitrary number of actions, and a corresponding number of decisions, that need to be taken during a call, with the goal of optimizing a global cost measure (e.g. the cost per call for customer care). At a finer level, each step taken in the interaction with the caller can be the result of a decision taken for optimizing a measure of cost defined for the overall service.

### SUMMARY OF THE INVENTION

The invention described here is aimed at the solution of the above described problem, which is the optimization—with respect to a global cost criterion of a set of decision rules devoted to select one of a set of finite actions that would influence the course of the interaction with the caller.

The invention is based on the use of the historic data that is typically logged during the course of several interactions of many users with the system in its normal operations. In other words, one assumes that the IVR process to be optimized has been deployed for enough time so that a large amount of data has been collected. The data would include the value of features that may influence the decision with respect to the optimization criterion. For instance, in the previous example where the cost is directly related to the outcome of the call (i.e. successful completion in the IVR, or transfer to a human agent), some features that are to be taken into consideration (but not limited thereto) are the time into the call, the total number of speech recognition no-matches (i.e. the speech recognizer is not able to return a valid word or phrase) during the course of the interaction, the number of timeouts (i.e. the user not providing any speech input when prompted), the average elapsed time between prompts and user responses, and the type of problem reported by the caller. Other features that may indirectly influence the outcome of a call are the time of the day and the day of the week, since these determine the distribution of a caller's experience (e.g. computer savvy users, who demonstrate more confidence in using automated systems and thus have a higher chance of a successful outcome for the call, generally call during weeknight hours or during weekends). These features may be considered as points of evidence that can be used in making a determination on the likelihood the IVR can or cannot solve the problem.

The collected historic data is used to estimate the parameters of a decision function that optimizes the global cost criterion. Once the parameters of the decision function are estimated, the decision function can be invoked at any time during the execution of the IVR system in order to select the action that would cause the optimization of the global criterion (e.g. overall reduction of cost). If the environmental conditions at the time of use of the decision function are not different from those present at the time when the decision function parameters were estimated, then decisions made according to the decision functions, optimizes the cost criterion at the best of the available knowledge.

There is therefore presented according to the present invention a technique for optimizing the cost of interaction with a caller utilizing an automated interactive voice response system. A plurality of interactions between historical callers and an automated interactive voice response system are recorded and then analyzed. Discrete attributes of the interactions between the callers and the automated interactive voice response system are recorded. A set of logical statements relative to the discrete attributes is formulated, and this set of logical statements is applied to the interaction with said caller. An action based on the application of the logical statements to the interactions with said caller is determined.

These and other features of the invention will be more fully understood from the following description of specific embodiments of the invention taken together with the accompanying drawings.

### BRIEF DESCRIPTION OF THE DRAWINGS

FIG. 1 is a block diagram depiction of a system for implementing the present invention.

FIG. 2 is a flow chart depicting the operational steps of the technique according to the present invention.

### DETAILED DESCRIPTION OF THE INVENTION

The invention described here can be realized by an analytical function:

d=D(P,F)

where d=(1, 2, . . . , M) is the index or scale of values, of one of a finite set of M actions (a₁, a₂, . . . , a_{M}) to be taken at a given point during the interaction. F is a vector of features that are estimated and given an actual value during the interaction. These features may include but are not limited to, for example, the time elapsed from the beginning of the call t, the ordinal number of the current caller turn (the number of separate questions and answers solicited from the caller) N_{T}, the number of speech recognition no-matches experienced by the caller since the beginning of the interaction N_{NM}, the number of time-outs experienced by the system since the beginning of the interaction N_{TO}, the time of day T_{D}, the day of the week dw, and other parameters that are believed to influence the optimal decision. Thus, the vector F, without any loss in generality, may assume the following general form:

F=(F1,F2,F3, . . . ,FN)

and, in particular, the vector F may assume the form:

F=(t,N_{T},N_{NM},N_{TO},T_{D},dw . . . )

Without any loss in generality, the function D is expressed in a parametric form, with a number Q of free parameters described by the vector P:

P=(p₁,p₂,p₃ . . . ,p_{Q})

One of many machine learning algorithms available as prior art and described in the machine learning literature can be used in conjunction with a set of training examples to estimate the parameters P of a generic parametric function in order to optimize a defined measurable criterion. For that purpose, a set T of L training examples

T=(T₁,T₂, . . . T_{L})

can be constructed from historic interaction data in the following way: for each caller interaction turn j of each call k in the set of calls that belong to the historic data, the actual feature vector F_{k,j} can be recorded. So, a training example Tₖ will be recorded as the following sequence of feature vectors:

Tₖ=(F_{k,1}F_{k,2}, . . . Fₖ,Rₖ,Oₖ)

where Rₖ is the actual number of turns for that call and Oₖ is the actual outcome of the call that is directly related to the overall cost function. For instance, in the example described above the outcome of the call can be either successful or unsuccessful.

Using an available machine learning algorithm the parameters P of the function D can be estimated in order to optimize the capacity of the technique according to the present invention to choose the best action (e.g., continue or transfer in the previous example) with respect to the chosen optimization criterion. For example, the chosen optimization criterion may include minimize the cost of all caller interactions. For that chosen optimization criterion, the automated IVR would continue without transferring the call to a live operator or transfer the call, depending on the actual values of the feature vector F obtained during the actual interaction. Once the function D is estimated, the function can be used at each turn or step of each interaction for selecting the action that would optimize the defined global criterion.

The operation of the present invention decision function, as set forth hereinbefore, as; d=D(P, F) wherein F is a vector of features and P is a vector of parameters related to each feature or combination of features may be set forth in the following exemplary descriptions. In this example the features as previously set forth may include, for example, the time elapsed from the beginning of the call t, the ordinal number of the current caller turn N_{T}, the number of speech recognition no-matches experienced by the caller since the beginning of the interaction N_{NM}, the number of time-outs experienced by the system since the beginning of the interaction N_{TO}, the time of day T_{D}, the day of the week dw, and other attributes that are believed to influence the optimal decision. The parameters P related to such features that optimize the decision according to the established optimality criterion are identified through a machine learning algorithm based on historical interactions between callers and call centers, in other words a record of prior calls between callers and an automated interactive voice response system. In the machine learning algorithm, software, which embodies the algorithm may be “trained” on test cases, in this case the historical interactions, and scored so the software knows what outcomes correspond to the chosen optimization criterion. Once trained on the historical examples, the features and parameters identified may then be used to solve real-world cases. The machine learning algorithm can identify and record distinct features for an interaction between a caller and call center as well as the outcome of the call, for example either successful or unsuccessful. The historical interactions assessed by the machine learning algorithm may be referred to as training examples. The set of features compiled during the training examples may then used to construct any number of parameters, or rules, which may be implemented to optimize the overall cost of customer care. The parameters may be logical statements relative to each feature or combination of features, and may take the form, for example, of an “if-then” or Boolean logical operation. However, the present invention is not so limited to include only “if-then” or Boolean logical operations. Other more complex relationships between the features may be developed to refine the process of optimizing the cost of customer care.

For example, a feature identified in a training example may include the time of day T_{D}. For the time of day feature, a set of parameters or rules may then be developed based on recorded outcomes for any particular time of day. Therefore for each time of day, a parameter may be established. An example of such a parameter may be stated as; if call is initiated after 11:00 pm, then immediately direct the call to a live operator. The rule would be based on the training example interactions which may have shown that when a call is initiated after 11:00 pm, the automated call outcome is unsuccessful for a large percentage of calls, therefore, the overall cost of customer care is optimized by immediately directing the call to a live operator rather than utilizing an automated system for even a portion of the call interaction.

The machine learning algorithm may establish such a parameter by determining the optimal percentage of success versus unsuccessful outcomes for each time of day in order to optimize the overall cost of customer care. In other words as the ratio of unsuccessful to successful calls increases for each time of day measured in a training example, the decision function will identify the optimal ratio or percentage of unsuccessful outcomes where an automated call should be switched to a live operator.

Additionally, a parameter may be based on one or more than one feature, for example time of day T_{D}. the time elapsed from the beginning of the call t, and the number of speech recognition no-matches experienced by the caller since the beginning of the interaction N_{NM}. In this example a parameter may be established through the training examples such that calls initiated between 2:00 pm and 3:00 pm with an elapsed time greater than 5 minutes, having more than 3 speech recognition no matches, are transferred to a live operator.

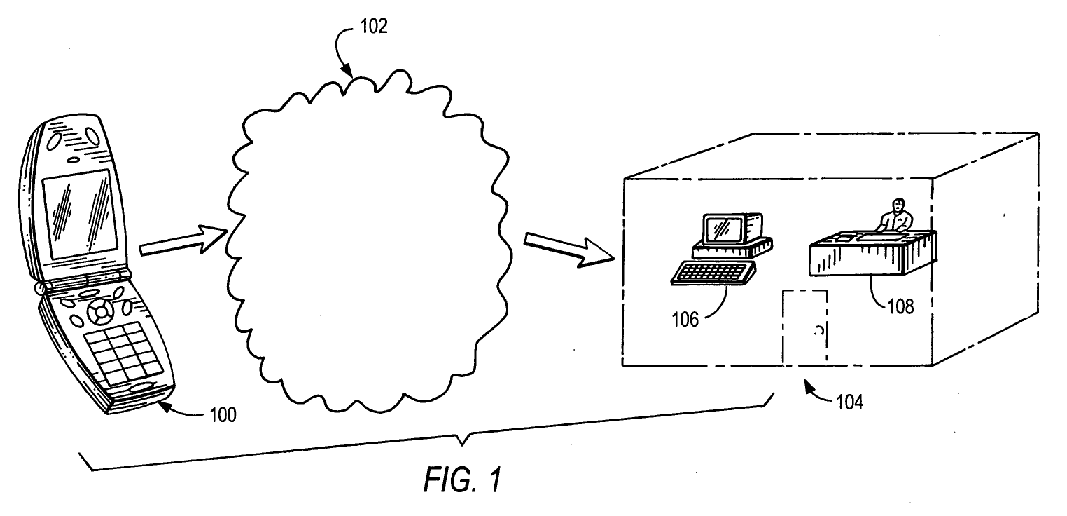

Turning now to FIG. 1, there is shown a block diagram depiction of a system for implementing the present invention. FIG. 1 depicts an exemplary network for implementing the technique according to the present invention. There is depicted a phone 100 for use by a caller, which may transmit a call through any known voice transmission technology, either wired or wireless, using a voice transmission network 102, such as a PSTN, wireless voice network such as for example a cdma, gsm or 3G wireless network. One skilled in the art will recognize that the present invention is not so limited as to the voice transmission networks given as examples herein and may utilize any appropriate voice network. The caller utilizing a phone 100 and the voice network 102 may connect to a call center 104 for customer care and be connected to an automated IVR. The call center may house both the automated IVR, which may typically be implemented using software on a computer system 106, as well as live agents 108 for responding to an incoming call from a caller. The automated IVR may be embodied in software implementing the technique according to the present invention, wherein a call received from a caller may be answered by the automated IVR and then in accordance with the Decision Function described above, the automated IVR may continue the interaction with the caller or may transfer the call to a live operator in accordance with the chosen optimization criterion. As shown in FIG. 1, calls may be transferred to a live operator 108 in accordance with the chosen optimization criterion. As stated above, while the cost of the live operator may be greater than the automated IVR, satisfactory resolution of a customers needs may sometimes require the transfer of a call to the live operator. The chosen optimization criteria may thus be maximized to account for not only minimizing the cost of all caller interactions but also to account for reaching a successful outcome with the caller.

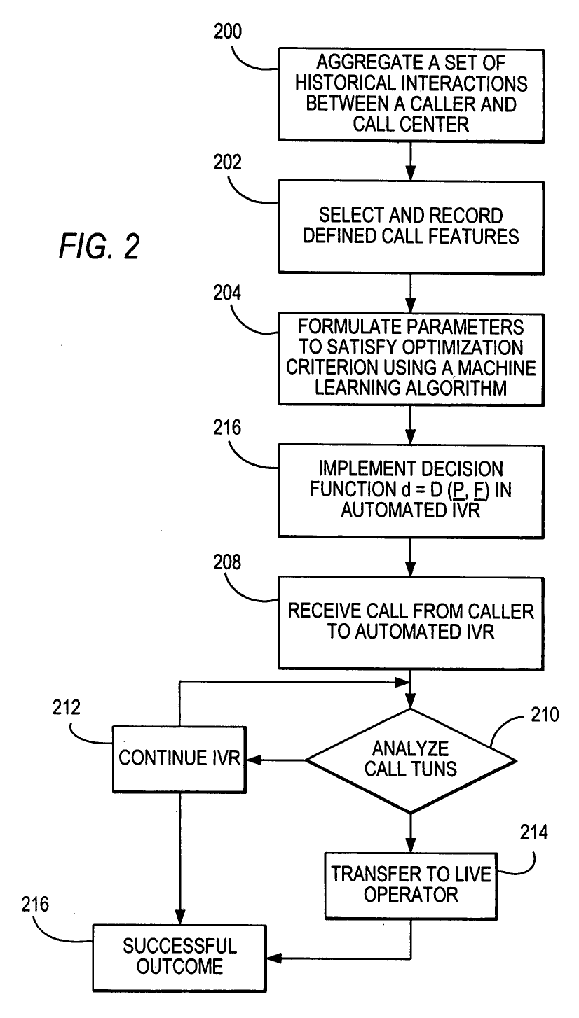

Turning now to FIG. 2, there is shown is a flow chart depicting the operational steps for implementing the technique according to the present invention. In step one (1) 200, a set of historical interactions between a caller and a call center are aggregated. The historical interactions assessed by the machine learning algorithm may be referred to as training examples. As previously stated the historical interactions may be a record of a statistically significant number of phone calls made to an automated IVR, operating with a predetermined and consistent set of caller interaction steps. In Step two (2), 202, specific attributes or features of the interaction that may affect the set of decision to be taken between the caller and call center are identified based on common sense and the aggregated historical interactions between callers and call centers from step (1), 200. The specific features identified in step (2) may include for example, the time elapsed from the beginning of the call t, the ordinal number of the current caller turn N_{T}, the number of speech recognition no-matches experienced by the caller since the beginning of the interaction N_{NM}, the number of time-outs experienced by the system since the beginning of the interaction N_{TO}, the time of day T_{D}, the day of the week dw as stated above.

As previously stated above, the machine learning algorithm, software, which embodies the algorithm may be “trained” on test cases, in this case the historical interactions, and scored so the software knows what outcomes correspond to the chosen optimization criterion. Step three (3), 204 comprises constructing with a machine learning algorithm any number of parameters, or rules, which may be implemented to optimize the overall cost of customer care from the set of features compiled during the training examples. The parameters may be logical statements relative to features or combination of features, and may take the form, for example, of an “if-then” or Boolean logical operation. However, the present invention is not so limited to include only “if-then” or Boolean logical operations. Other more complex relationships between the features may be developed to refine the process of optimizing the cost of customer care. A specific example of such a parameter established in step (3) may include: If the time elapsed from the beginning of the call is greater than 10 minutes, then transfer the call to a live operator. As previously explained any number of other parameters may be established from the features recorded from the training examples.

In step four (4) 206 a decision function in accordance with the technique of the present invention may be implemented within an automated IVR call center. The decision function d=D(P,F) utilizing the technique of the present invention may be used at each turn or step of each caller interaction for selecting the action that would optimize the defined global criterion. Step five (5) 208, includes receiving a call from a caller to an automated IVR in accordance with the present invention. Each turn or step of the interaction with the caller based on the decision function is analyzed in accordance with the decision function in step six (6) to determine if any parameter established in step (3) 204 of the decision function is invoked. Step seven (7) comprises either continuing the IVR interaction 212 or transferring 214 the call to a live operator for completion to a successful outcome 216. As is depicted in the flow chart, step (7) is an iterative process that may be repeated for each turn or step of each call. In the case where the IVR is continued, each turn is analyzed successively throughout the call in accordance with the decision function to determine if the automated IVR should be continued to a successful outcome 216, or transferred to a live operator 214.

One skilled in the art will further recognize that features other than those listed above are possible and may be obtained by common sense and by using knowledge of the application and the behavior of callers. Other exemplary features may include the originating area code of the call, the day of the week or calendar date. Likewise in addition to the exemplary parameters stated above, other logical statements relative to other features and combinations of features, defined through a machine learning algorithm may be developed. The present invention is not limited by the features and parameters disclosed herein. Any number of parameters may be developed and combined for optimizing the decision function.

While preferred embodiments of the present invention have been described using specific terms, such description is for illustrative purpose only. It is obvious that changes and variations may be made by those skilled in the art without departing from the scope of the claims. Therefore, the changes and variations are understood to be contained in the spirit or scope of the claims that follow.

What is claimed is:

1. A method for optimizing the cost of an interaction with a caller utilizing an automated interactive voice response system comprising:
analyzing a plurality of interactions between historical callers and said automated interactive voice response system;
recording discrete attributes of said interactions between said historical callers and said automated interactive voice response system;
formulating a set of logical statements relative to said discrete attributes;
applying said set of logical statements to said interaction with a caller; and
executing an action based on the application of said logical statements to said interaction with said caller.

2. A method for optimizing the cost of interaction with a caller utilizing an automated interactive voice response system according to claim 1 wherein said plurality of interactions between historical callers and said automated interactive voice response system comprises historical call interaction data.

3. A method for optimizing the cost of interaction with a caller utilizing an automated interactive voice response system according to claim 2 wherein said historical interaction data is recorded as a sequence of feature vectors in the form of Tₖ=(F_{k,1} F_{k,2}, . . . Fₖ,Rₖ,Oₖ) wherein, Tₖ is a training example, F_{k,j} is a feature vector recorded for each caller interaction turn j of each call k in the set of calls that belong to the historic data, Rₖ is the actual number of turns for that call and Oₖ is the actual outcome of the call.

4. A method for optimizing the cost of interaction with a caller utilizing an automated interactive voice response system according to claim 1 wherein said discrete attributes are recorded as a vector in the form of F=(F1, F2, F3, . . . , FN) wherein the variables of vector F are individual attributes.

5. A method for optimizing the cost of interaction with a caller utilizing an automated interactive voice response system according to claim 4 wherein said individual attributes are recorded as a vector in the form of F=(t, N_{T}, N_{NM}, N_{TO}, T_{D}, dw, dy, Cac . . . ), wherein t is time elapsed from the beginning of the call, N_{T} is the ordinal number of the current caller turn, N_{NM} is the number of speech recognition no-matches experienced by the caller since the beginning of the interaction, N_{TO} is the number of time-outs experienced by the system since the beginning of the interaction, T_{D} is the time of day, dw is the day of the week, dy is the day of the year, and Cac is the area code of the caller.

6. A method for optimizing the cost of interaction with a caller utilizing an automated interactive voice response system according to claim 1 wherein the action that is executed is determined in accordance with an analytical function of the form d=D(P,F) where d is the index or scale of values of one of a finite set of actions to be taken at a given point during the interaction. F is a vector of features and P is a vector of parameters related to said features or combinations of said features.

7. A method for optimizing the cost of interaction with a caller utilizing an automated interactive voice response system according to claim 6 wherein said set of logical statements is formulated as a number Q of parameters described by said vector P, in the form of P=(p₁, p₂, p₃ . . . , p_{Q}).

8. A method for optimizing the cost of interaction with a caller utilizing an automated interactive voice response system according to claim 6 wherein d=(1, 2, . . . , M) is the index of one of a finite set of M actions (a₁, a₂, . . . , aₘ) to be taken at a given point during said interaction.

9. A method for optimizing the cost of interaction with a caller utilizing an automated interactive voice response system according to claim 1 wherein said plurality of interactions between a caller and said automated interactive voice response system, is represented as a set T of L training examples of the form T=(T₁, T₂, . . . T_{L}).

10. A method for optimizing the cost of a communication with a caller utilizing an automated interactive voice response system according to claim 1 wherein said set of logical statements relative to said discrete attributes is formulated by developing a set of rules controlling said interaction with a caller utilizing said automated interactive voice response system for at least one of said discrete attributes.

11. A method for optimizing the cost of interaction with a caller utilizing an automated interactive voice response system according to claim 1 wherein said set of logical statements is applied to an interaction with said caller, by correlating at least one of said set of logical statement to said interaction to cause a predetermined outcome.

12. A method for optimizing the cost of interaction with a caller utilizing an automated interactive voice response system according to claim 11 wherein said predetermined outcome includes continuing the call with an automated IVR.

13. A method for optimizing the cost of interaction with a caller utilizing an automated interactive voice response system according to claim 11 wherein said predetermined outcome includes transferring a call to a live operator.

14. A method for optimizing the cost of an interaction with a caller utilizing an automated interactive voice response system according to claim 1, wherein said method is computer implemented.
